(19) United States
(12) Patent Application Publication
(10) Pub. No.: US 2022/0110321 A1
(43) Pub. Date: Apr. 14, 2022

(54) METHOD FOR CONTROLLING WEED

(71) Applicant: SUMITOMO CHEMICAL COMPANY, LIMITED, Chuo-ku (JP)

(72) Inventors: Yoshinao SADA, Kasai-shi (JP); Yoshinobu JIN, Kasai-shi (JP)

(73) Assignee: SUMITOMO CHEMICAL COMPANY, LIMITED, Chuo-ku (JP)

(21) Appl. No.: 17/417,628

(22) PCT Filed: Dec. 20, 2019
(86) PCT No.: PCT/JP2019/050056

§ 371 Date: Jun. 23, 2021

(30) Foreign Application Priority Data
Dec. 26, 2018 (JP) 2018-242253

(51) Int. Cl. A01N 37/40; A01P 13/00

(52) U.S. Cl. CPC A01N 37/40; A01P 13/00

(57) ABSTRACT

The present invention relates to a method for controlling a dicamba-resistant weed, including the step of: applying dicamba or a salt thereof and at least one different herbicide to the dicamba-resistant weed or a habitat of the dicamba-resistant weed. According to the present invention, a method that exhibits an excellent control effect in weed control can be provided.

### TECHNICAL FIELD

This patent application claims the priority and benefit from the Paris Convention based on Japanese Patent Application No. 2018-242253 (filed on Dec. 26, 2018), and the entire contents described in the application are incorporated herein by reference.

The present invention relates to a method for controlling a weed.

### BACKGROUND ART

Conventionally, as a method for controlling a weed, a method of applying dicamba or a salt thereof is known (see Patent Document 1). Dicamba-resistant weeds are known (See Non-Patent Documents 1 and 2).

### CITATION LIST

### Patent Document

Patent Document 1: U.S. Pat. No. 3,013,054

### Non-Patent Document

Non-Patent Document 1: Proc. Natl. Acad. Sci. 115 (2018), E2911-E2920.

Non Patent Document 2: Agronomy 8 (2018), 140.

### SUMMARY OF THE INVENTION

### Problems to be Solved by the Invention

An object of the present invention is to provide a method that exhibits an excellent control effect in weed control.

### Means for Solving the Problems

The present inventors have found that a combined use of dicamba or a salt thereof and at least one different herbicide exhibits an excellent control effect on dicamba-resistant weeds.

The present invention includes [1] to [5] below.

[1] A method for controlling a dicamba-resistant weed, including the step of:

applying dicamba or a salt thereof and at least one different herbicide to the dicamba-resistant weed or a habitat of the dicamba-resistant weed.

[2] The method according to [1], wherein the at least one different herbicide is selected from a group consisting of the following B-1 to B-11:

B-1 acetolactate synthase inhibitors;

B-2 acetyl-CoA carboxylase inhibitors;

B-3 protoporphyrinogen IX oxidase inhibitors;

B-4 4-hydrophenylpyruvate dioxygenase inhibitors;

B-5 phytoene desaturase inhibitors;

B-6 photosystem II inhibitors;

B-7 very long chain fatty acid synthesis inhibitors;

B-8 microtubule formation inhibitors;

B-9 enolpyruvylshikimate 3-phosphate synthase inhibitors;

B-10 glutamine synthase inhibitors; and

B-11 other herbicides;

(including salts or derivatives thereof).

[3] The method according to [1] or [2], wherein the habitat of the dicamba-resistant weed is a cultivation area of a crop.
[4] The method according to [3], wherein the crop is one selected from the group consisting of soybean, corn, cotton, rapeseed, rice, wheat, barley, sugarcane, sugarbeet, sorghum, and sunflower.
[5] The method according to [3], wherein the crop is a crop to which tolerance to dicamba or a salt thereof is imparted.

### Effect of the Invention

According to the method for controlling a weed of the present invention, a high weed control effect can be obtained.

### MODE FOR CARRYING OUT THE INVENTION

The method for controlling a dicamba-resistant weed of the present invention (hereinafter, it may be referred to as the method of the present invention) includes the step of applying a combination of dicamba or a salt thereof (hereinafter, it may be referred to as the present compound) and at least one different herbicide (hereinafter, it may be referred to as the present combination).

When the present compound is a salt, the salt is not particularly limited as long as it is an agronomically acceptable salt, and examples thereof include dicamba BAPMA (N,N-bis(3-aminopropyl)methylamine) salt, dicamba-trolamine, dicamba-diglycolamine, dicamba-dimethylammonium, dicamba-diolamine, dicamba-isopropylammonium, dicamba-methyl, dicamba-olamine, dicamba-potassium, dicamba-sodium.

Hereinafter, when at least one compound selected from a group consisting of herbicide compound group B is a salt (e.g. glyphosate-potassium salt), its weight represents in terms of acid equivalence.

In the present combination, the weight ratio of at least one different herbicide relative to dicamba or a salt thereof is usually in the range of 0.001 times amount to 100 times amount, preferably in the range of 0.01 times amount to 10 times amount, and more preferably in the range of 0.1 times amount to 5 times amount. Examples of further more preferable ratios include 0.2 times amount, 0.4 times amount, 0.6 times amount, 0.8 times amount, an equivalent amount, 1.5 times amount, 2 times amount, 2.5 times amount, 3 times amount, and 4 times amount. The above-mentioned ratios can also be expressed with approximately. Approximately means plus or minus 10%, and for example, “approximately 2 times amount” is 1.8 times amount to 2.2 times amount.

In the present combination, Examples of at least one herbicide different from dicamba include the following.

B-1 acetolactate synthase inhibitors;

pyrithiobac, pyrithiobac-sodium salt, pyriminobac, pyriminobac-methyl, bispyribac, bispyribac-sodium salt, pyribenzoxim, pyrimisulfan, pyriftalid, triafamone, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron, trifloxysulfuron-sodium salt, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropylammonium salt, imazaquin, imazaquin-ammonium, imazethapyr, and imazethapyr-ammonium salt

(including salts and derivatives thereof),

B-2 acetyl-CoA carboxylase inhibitors;

clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, and pinoxaden

(including salts and derivatives thereof),

B-3 protoporphyrinogen IX oxidase inhibitors;

azafenidin, oxadiazon, oxadiargyl, carfentrazone, carfentrazone-ethyl, saflufenacil, cinidon, cinidon-ethyl, sulfentrazone, pyraclonil, pyraflufen, pyraflufen-ethyl, butafenacil, fluazolate, fluthiacet, fluthiacet-methyl, flufenpyr, flufenpyr-ethyl, flumiclorac, flumiclorac-pentyl, flumioxazin, pentoxazone, oxyfluorfen, acifluorfen, acifluorfen-sodium salt, aclonifen, chlormethoxynil, chlornitrofen, nitrofen, bifenox, fluoroglycofen, fluoroglycofen-ethyl, fomesafen, fomesafen-sodium salt, lactofen, tiafenacil, trifludimoxazin and ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate

(including salts and derivatives thereof),

B-4 4-hydrophenylpyruvate dioxygenase inhibitors;

benzobicyclon, bicyclopyrone, mesotrione, sulcotrione, tefuryltrione, tembotrione, isoxachlortole, isoxaflutole, benzofenap, pyrasulfotole, pyrazolynate, pyrazoxyfen, fenquinotrione, topramezone, tolpyralate, lancotrione, lancotrione-sodium salt, 2-methyl-N-(5-methyl-1,3,4-oxadiazol-2-yl)-3-(methylsulfonyl)-4-(trifluoromethyl)benzamide (CAS Registry Number: 1400904-50-8), 2-chloro-N-(1-methyl-1H-tetrazol-5-yl)-3-(methylthio)-4-(trifluoromethyl)benzamide (CAS Registry Number: 1361139-71-0), and 4-(4-fluorophenyl)-6-[(2-hydroxy-6-oxo-1-cyclohexene-1-yl)carbonyl]-2-methyl-1,2,4-triazine-3,5(2H,4H)-dione (CAS Registry Number: 1353870-34-4)

(including salts and derivatives thereof),

B-5 phytoene desaturase inhibitors;

diflufenican, picolinafen, beflubutamid, norflurazon, fluridone, flurochloridone, and flurtamone

(including salts and derivatives thereof),

B-6 photosystem II inhibitors;

ioxynil, ioxynil-octanoate, bentazone, pyridate, bromoxynil, bromoxynil-octanoate, chlorotoluron, dimefuron, diuron, linuron, fluometuron, isoproturon, isouron, tebuthiuron, benzthiazuron, methabenzthiazuron, propanil, metobromuron, metoxuron, monolinuron, siduron, simazine, atrazine, propazine, cyanazine, ametryn, simetryn, dimethametryn, prometryn, terbumeton, terbuthylazine, terbutryn, trietazine, hexazinone, metamitron, metribuzin, amicarbazone, bromacil, lenacil, terbacil, chloridazon, desmedipham, and phenmedipham

(including salts and derivatives thereof),

B-7 very long chain fatty acid synthesis inhibitors;

propachlor, metazachlor, alachlor, acetochlor, metolachlor, S-metolachlor, butachlor, pretilachlor, thenylchlor, indanofan, cafenstrole, fentrazamide, dimethenamid, dimethenamid-P, mefenacet, pyroxasulfone, fenoxasulfone, naproanilide, napropamide, anilofos, flufenacet, and ipfencarbazone

(including salts and derivatives thereof),

B-8 microtubule formation inhibitors;

trifluralin, pendimethalin, ethalfluralin, benfluralin, oryzalin, prodiamine, butamifos, dithiopyr, and thiazopyr

(including agricultural salts and derivatives thereof),

B-9 enolpyruvylshikimate 3-phosphate synthase inhibitors;

glyphosate, glyphosate-isopropylammonium salt, glyphosate-trimesium salt, glyphosate-ammonium salt, glyphosate-diammonium salt, glyphosate-dimethylammonium salt, glyphosate-monoethanolamine salt, glyphosate-sodium salt, glyphosate-potassium salt, and glyphosate-guanidine salt

(including salts and derivatives thereof),

B-10 glutamine synthase inhibitors;

glufosinate, glufosinate-ammonium salt, glufosinate-P, and glufosinate-P-sodium salt

B-11 other herbicides;

isoxaben, dichlobenil, methiozolin, diallate, butylate, triallate, chlorpropham, asulam, phenisopham, benthiocarb, molinate, esprocarb, pyributicarb, prosulfocarb, orbencarb, EPTC, dimepiperate, swep, difenoxuron, methyldymron, bromobutide, daimuron, cumyluron, diflufenzopyr, diflufenzopyr-sodium salt, etobenzanid, tridiphane, amitrole, clomazone, 2-[(2,4-dichlorophenyl)methyl]-4,4-dimethylisoxazolidin-3-one (CAS Registry Number: 81777-95-9), (3S,4S)-N-(2-fluorophenyl)-1-methyl-2-oxo-4-[3-(trifluoromethyl)phenyl]-3-pyrrolidinecarboxamide (CAS Registry Number: 2053901-33-8), maleic hydrazide, oxaziclomefone, cinmethylin, benfuresate, ACN, dalapon, chlorthiamid, flupoxam, bensulide, paraquat, paraquat-dichloride, diquat, diquat-dibromide, MSMA, indaziflam, and triaziflam

(including salts and derivatives thereof).

In the method of the present invention, a weed being resistant to dicamba refers to a state in which even a dose of dicamba or a salt thereof four times the minimum dose required to kill or irreparably suppress a wild-type weed of the same species cannot kill or irreparably suppress the weed, and such a type of a weed is referred to as a dicamba-resistant weed.

The habitat of the dicamba-resistant weed of the method of the present invention includes a place where the dicamba-resistant weed is growing and a place where the dicamba-resistant weed will grow.

The method of the present invention can be applied to non-agricultural land or agricultural land. The agricultural land is, for example, a cultivation area of plants listed below.

Crop; corn, rice, wheat, barley, rye, oat, sorghum, cotton, soybean, peanut, buckwheat, beet, rapeseed, sunflower, sugarcane, tobacco, triticale, kidney bean, lima bean, cowpea, mung bean, black gram, scarlet runner bean, rice bean, moth bean, tepary bean, broad bean, pea, chickbean, lentil, lupin, pigeon pea, alfalfa and the like,

Vegetable; Solanaceae vegetables (eggplant, tomato, piment, capsicum, potato, bell peppers and the like), Cucurbitaceae vegetables (cucumber, pumpkin, zucchini, watermelon, melon, squash and the like), Brassicaceae vegetables (radish, turnip, horseradish, coral-rabbi, Chinese cabbage, cabbage, Indian mustard, broccoli, cauliflower and the like), Compositae vegetables (burdock, corn marigold, artichoke, lettuce, and the like), Liliaceae vegetables (green onion, onion, garlic, asparagus), Umbelliferae vegetables (carrot, parsley, celery, parsnip and the like), Chenopodiaceae vegetables (spinach, chard and the like), Labiatae vegetables (perilla, mint, basil, lavender and the like), strawberry, sweet potato, yam, taro and the like, ornamental flower, and ornamental foliage plant,

Fruit tree; pome fruits (apple, pear, Japanese pear, Chinese quince, quince and the like), stone fruits (peach, plum, nectarine, Japanese plum, yellow peach, apricot, prune and the like), citrus plants (Citrus unshiu, orange, lemon, lime, grapefruit and the like), nuts (chestnut, walnut, hazelnut, almond, pistachio, cashew nut, macadamia nut and the like), berries (blueberry, cranberry, blackberry, raspberry and the like), grape, persimmon, olive, loquat, banana, coffee, date, coconut and the like,

Tree other than fruit tree; tea, mulberry, flowering trees and shrubs, street tree (ash, birch, dogwood, eucalyptus, ginkgo, lilac, maple, oak, poplar, cercis, Formosan gum, plane, zelkova, Japanese arborvitae, fir tree, hemlock, needle juniper, pine, spruce, yew) and the like, and

Turf grasses, Pasture grasses.

The method of the present invention is preferably applied to a cultivation area of a crop. The crop is preferably one selected from the group consisting of corn, cotton, rapeseed, rice, wheat, barley, sugarcane, sugarbeet, sorghum, and sunflower.

The “plant” described above can be a plant that can be produced by natural crossbreeding, a plant that can be generated by mutation, an F1 hybrid plant, or a transgenic plant (also referred to as a genetically-modified plant). These plants generally have characteristics such as impartment of tolerance to herbicides, accumulation of toxic substances to insect pests, suppression of sensitivity to diseases, increase in yield potential, improvement in resistance to biological and abiotic stress factors, accumulation of substances, and improvement in preservability and processability.

The F1 hybrid plant is a first filial hybrid obtained by crossbreeding two different line breeds, and is generally a plant having a trait superior to both of the parents and characteristics of heterosis. The transgenic plant is a plant having characteristics obtained by introduction of a foreign gene from other organisms such as microorganisms, which cannot be easily obtained by crossbreeding, mutagenesis, or natural recombination in a natural environment.

Examples of the technique for producing the above-mentioned plants include conventional breeding techniques; genetic engineering technique; genomic breeding technique; new breeding techniques; and genome editing technique. The conventional breeding techniques are a technique for obtaining a plant having desirable properties by mutation or crossbreeding. The genetic engineering technique is a technique of taking out a gene of interest (DNA) from a certain organism (for example, microorganism) and introducing the gene into a genome of another target organism to impart new properties to the target organism, and an antisense technique or RNA interference technique of silencing other genes present in a plant to impart new or improved characteristics. The genomic breeding technique is a technique for improving breeding efficiency using genome information, and includes a DNA marker (also referred to as a genome marker or a gene marker) breeding technique and genomic selection. For example, DNA marker breeding is a method of selecting a progeny having a useful trait gene of interest from a large number of crossbreeding progenies using a DNA marker that is a DNA sequence that serves as a mark of an existence position of a specific useful trait gene on a genome. In the method, the time required for breeding can be effectively shortened by analyzing the crossbreeding progeny using a DNA marker when the progeny is a seedling.

Genomic selection is a technique of creating a prediction formula from a previously obtained phenotype and genome information and predicting a characteristic from the prediction formula and the genome information without evaluating the phenotype, which is a technique that can contribute to improvement of breeding efficiency. The new breeding techniques are a generic term of breed improvement (breeding) techniques combined with molecular biological techniques. Examples thereof include cisgenesis/intragenesis, oligonucleotide-directed mutagenesis, RNA-dependent DNA methylation, genome editing, grafting to a GM rootstock or scion, reverse breeding, agroinfiltration, and Seed Production Technology (SPT). The genome editing technique is a technique of converting genetic information in a sequence-specific manner, which enables deletion of a base sequence, substitution of an amino acid sequence, introduction of a foreign gene and the like. Examples of a tool thereof include a zinc finger nuclease (Zinc-Finger, ZFN) which is capable of sequence-specific DNA cleavage, TALEN, CRISPR/Cas9, CRISPER/Cpf1, Meganuclease, and sequence-specific genome modification techniques such as CAS9 nickase and Target-AID produced by modifying the above-mentioned tools.

Examples of the above-mentioned plants include plants listed in a genetically modified crop registration database (GM APPROVAL DATABASE) in an electronic information site (http://www.isaaa.org/) of INTERNATIONAL SERVICE for the ACQUISITION of AGRI-BIOTECH APPLICATIONS (ISAAA). More specific examples thereof include herbicide-tolerant plants, pest-resistant plants, disease-resistant plants, plants in which the quality of products (for example, starch, amino acid, and fatty acid) is modified (for example, the content is increased or decreased, or composition is changed), fertility trait modified plants, abiotic stress-tolerant plants, and plants in which traits related to growth and yield are modified.

Examples of plants to which herbicide tolerance is imparted are as follows.

The mechanism of tolerance to a herbicide is obtained by, for example, decreasing of the affinity between a drug and its target, rapid metabolism (for example, decomposition or modification) of the drug by expression of an enzyme that inactivates the drug, or inhibition of uptake of the drug into a plant body or of transfer of the drug in the plant body.

Examples of plants to which herbicide tolerance is imparted by a genetic engineering technique include: plants to which tolerance to 4-hydroxyphenylpyruvate dioxygenase (hereinafter abbreviated as HPPD) inhibitors such as isoxaflutole and mesotrione, acetolactate synthase (hereinafter abbreviated as ALS) inhibitors such as imidazolinone herbicides such as imazethapyr and sulfonylurea herbicides such as thifensulfuron-methyl, 5-enolpyruvylshikimate-3 phosphate synthase (hereinafter abbreviated as EPSPS) inhibitors such as glyphosate, glutamine synthetase inhibitors such as glufosinate, auxin-type herbicides such as 2,4-D, oxynyl herbicides such as bromoxynil, or protoporphyrinogen oxidase (hereinafter abbreviated as PPO) inhibitors such as flumioxazine is imparted by genetic engineering technique. Preferable herbicide-tolerant transgenic plants are cereals such as wheat, barley, rye, and oat; and vegetables such as canola, sorghum, soybean, rice, rapeseed, beet, sugarcane, grape, lentil, sunflower, alfalfa, pome fruits, stone fruits, coffee, tea, strawberry, zoysia, tomato, potato, cucumber, and lettuce; and more preferable herbicide-tolerant transgenic plants are cereals such as wheat, barley, rye, and oat; soybean, rice, Vine, tomato, potato, and pome fruits.

Specific herbicide-tolerant plants are shown below.

Glyphosate herbicide-tolerant plants; The plants are obtained by introduction of at least one of a glyphosate-tolerant EPSPS gene (CP4 epsps) derived from Agrobacterium tumefaciens strain CP4, a glyphosate metabolic enzyme gene (gat 4601, gat 4621) in which the metabolic activity of the glyphosate metabolic enzyme (glyphosate N-acetyltransferase) gene derived from Bacillus licheniformis is enhanced by a shuffling technique, a glyphosate metabolic enzyme (glyphosate oxidase gene, goxv 247) derived from an Ochrobacterum anthropi strain LBAA strain, and an EPSPS gene (mepsps, 2mepsps) having a glyphosate tolerance mutation derived from corn. Examples of main plants include alfalfa (Medicago sativa), Argentina canola (Brassica napus), cotton (Gossypium hirsutism L.), creeping bentgrass (Agrostis stolonifera), corn (Zea mays L.) polish canola (Brassica rapa), potato (Solanum tuberosum L.), soybean (Glycine max L.), beet (Beta vulgaris), and wheat (Triticum aestivum). Some glyphosate-tolerant transgenic plants are commercially available. For example, a genetically-modified plant that expresses glyphosate-tolerant EPSPS derived from Agrobacterium is sold under a trade name such as “Roundup Ready (registered trademark)”, a genetically-modified plant that expresses a glyphosate metabolic enzyme derived from a Bacillus bacterium in which the metabolic activity is enhanced by a shuffling technique is sold under a trade name such as “Optimum (registered trademark) GAT (trademark)” and “Optimum (registered trademark) Gly canola”, and a genetically modified plant that expresses EPSPS having a glyphosate-tolerant mutation derived from corn is sold under the trade name “GlyTol (trademark)”.

Glufosinate herbicide-tolerant plants; The plants are obtained by introduction of at least one of a phosphinothricin N-acetyltransferase (PAT) gene (bar) which is a glufosinate metabolic enzyme derived from Streptomyces hygroscopicus, a phosphinothricin N-acetyltransferase (PAT) enzyme gene (pat) which is a glufosinate metabolic enzyme derived from Streptomyces viridochromogenes, and a synthesized pat gene (pat syn) derived from Streptomyces viridocromogenes strain Tu 494. Examples of main plants include Argentina canola (Brassica napus), chicory (Cichorium intybus), cotton (Gossypium hirsutum L.), corn (Zea mays L.), polish canola (Brassica rapa), rice (Oryza sativa L.), soybean (Glycine max L.), and beet (Beta vulgaris). Some glufosinate-tolerant genetically-modified plants are commercially available. The glufosinate metabolic enzyme (bar) derived from Streptomyces hygroscopicus and the genetically-modified plant derived from Streptomyces viridochromogenes are sold under trade names such as “LibertyLink (trademark)”, “InVigor (trademark)”, and “WideStrike (trademark)”. Oxynyl herbicide (for example, bromoxynil)-tolerant plants; Examples thereof include an oxynyl herbicide-tolerant, for example, bromoxynil-tolerant transgenic plant to which a nitrilase gene (bxn) which is an oxynyl herbicide (for example, bromoxynyl) metabolic enzyme derived from Klebsiella pneumoniae subsp. Ozaenae is introduced. Examples of main plants include Argentina canola (Brassica napus), cotton (Gossypium hirsutum L.), and tobacco (Nicotiana tabacum L.). These are sold under trade names such as “Navigator (trademark) canola” and “BXN (trademark)”. ALS herbicide-tolerant plants; carnation (Dianthus caryophyllus) to which the ALS herbicide-tolerant ALS gene (surB) derived from tobacco (Nicotiana tabacum) as a selective marker is introduced, “Moondust (trademark)”, “Moonshadow (trademark)”, “Moonshade (trademark)”, “Moonlite (trademark)”, “Moonaqua (trademark)”, “Moonvista (trademark)”, “Moonvista (trademark)”, “Moonique (trademark)”, “Moonpearl (trademark)”, “Moonberry (trademark)”, and “Moonvelvet (trademark)”; flax (Linum usitatissumum L.) to which the ALS herbicide-tolerant ALS gene (als) derived from Arabidopsis thaliana is introduced, “CDC Triffid Flax”; corn (Zea mays L.) tolerant to sulfonylurea and imidazolinone herbicides to which ALS herbicide tolerant ALS gene (zm-hra) derived from corn is introduced, “Optimum (trademark) GAT (trademark); soybean tolerant to imidazolinone herbicide to which ALS herbicide tolerant ALS gene (csr1-2) derived from Arabidopsis thaliana is introduced, “Cultivance”; and soybean tolerant to sulfonylurea herbicide to which ALS herbicide-tolerant ALS gene (gm-hra) derived from soybean (Glycine max) is introduced, which is sold under trade names of “Treus (trademark)”, “Plenish (trademark)” and “Optimum GAT (trademark)”. Examples thereof include cotton to which the ALS herbicide-tolerant ALS gene (S4-HrA) derived from tobacco (Nicotiana tabacum cv.Xanthi) is introduced. HPPD herbicide-tolerant plants; soybean to which the HPPD gene (avhppd-03) tolerant to mesotrione derived from oat (Avena sativa) and the phosphinothricin N-acetyltransferase (PAT) enzyme gene (pat) that exhibits tolerance to mesotrione, which is a glufosinate metabolic enzyme derived from Streptomyces viridochromogenes, are simultaneously introduced is sold under the trade name of “Herbicide-tolerant Soybean line”.

2,4-D-tolerant plants; corn to which the aryloxyalkanoate dioxygenase gene (aad-1), which is a 2,4-D metabolic enzyme derived from Sphingobium herbicidovorans, is introduced is sold under the trade name of Enlist (trademark) Maize. Examples thereof include soybean and cotton to which the aryloxyalkanoate dioxygenase gene (aad-12), which is a 2,4-D metabolic enzyme derived from Delftia acidovorans, is introduced, and these are sold under the trade name of “Enlist (trademark) Soybean”.

Dicamba-tolerant plants; Examples thereof include soybean and cotton to which the Dicamba monooxygenase gene (dmo), which is a dicamba metabolic enzyme derived from Stenotrophomonas maltophilia strain DI-6, is introduced. Soybean (Glycine max L.) to which the glyphosate-tolerant EPSPS gene (CP4 epsps) derived from Agrobacterium tumefaciens strain CP4 is introduced simultaneously with the above-mentioned gene is sold under the trade name of “tenuity (registered trademark) Roundup Ready (trademark) 2 Xtend (trademark)”.

PPO Inhibitor-tolerant plants; Examples thereof include a plant to which protoporphyrinogen oxidase having a reduced affinity with a PPO inhibitor is imparted by genetic engineering technique, and a plant to which cytochrome P450 monooxygenase that detoxifies and degrades a PPO inhibitor is similarly imparted. Examples thereof also include a plant to which both the protoporphyrinogen oxidase and the cytochrome P450 monooxygenase are imparted. These plants are described in known documents, and examples of such documents include Patent Documents such as WO 2011085221, WO 2012080975, WO 2014030090, WO 2015022640, WO 2015022636, WO 2015022639, WO 2015092706, WO 2016203377, WO 2017198859, WO 2018019860, WO 2018022777, WO 2017112589, WO 2017087672, WO 2017039969, and WO 2017023778, and Non-Patent Document (Pest Management Science, 61, 2005, 277-285).

Examples of commercially available transgenic plants to which herbicide tolerance is imparted include corn tolerant to glyphosate, “Roundup Ready Corn”, “Roundup Ready 2”, “Agrisure GT”, “Agrisure GT/CB/LL”, “Agrisure GT/RW”, “Agrisure 3000 GT”, “YieldGard VT Rootworm/RR2”, and “YieldGard VT Triple”; soybean tolerant to glyphosate, “Roundup Ready Soybean” and “Optimum GAT”; cotton tolerant to glyphosate, “Roundup Ready Cotton” and “Roundup Ready Flex”; canola tolerant to glyphosate, “Roundup Ready Canola”; alfalfa tolerant to glyphosate, “Roundup Ready Alfalfa”; rice tolerant to glyphosate, “Roundup Ready Rice”; corn tolerant to glufosinate, “Roundup Ready 2”, “Liberty Link”, “Herculex 1”, “Herculex RW”, “Herculex Xtra”, “Agrisure GT/CB/LL”, “Agrisure CB/LL/RW”, and “Bt 10”; cotton tolerant to glufosinate, “FiberMax Liberty Link”; rice tolerant to glufosinate, “Liberty Link Rice”; canola tolerant to glufosinate, “in Vigor”; rice tolerant to glufosinate, “Liberty Link Rice” (Bayer product); cotton tolerant to bromoxynil, “BXN”; and canola tolerant to bromoxynil, “Navigator”, “Compass”. Further plants modified for herbicides are widely known, and examples thereof include alfalfa, apple, barley, eucalyptus, flax, grape, colza, rapeseed, pea, potato, rice, beet, sunflower, tobacco, tomato, lawn grass, and wheat which are tolerant to glyphosate (See, for example, U.S. Pat. Nos. 5,188,642, 4,940,835, 5,633,435, 5,804,425, and 5,627,061); bean, cotton, soybean, pea, potato, sunflower, tomato, tobacco, corn, sorghum, and sugarcane which are tolerant to dicamba (See, for example, WO 2008051633, U.S. Pat. Nos. 7,105,724 and 5,670,454); soybean, beet, potato, tomato, and tobacco which are tolerant to glufosinate (See, for example, U.S. Pat. Nos. 6,376,754, 5,646,024, 5,561,236); cotton, peppers, apple, tomato, sunflower, tobacco, potato, corn, cucumber, wheat, soybean, sorghum, and minor cereals which are tolerant to 2,4-D (See, for example, U.S. Pat. Nos. 6,153,401 and 6,100,446, WO 2005107437, U.S. Pat. Nos. 5,608,147 and 5,670,454); and canola, corn, millet, barley, cotton, Indian mustard, lettuce, lentils, melon, foxtail millet, oat, rapeseed, potato, rice, rye, sorghum, soybean, beet, sunflower, tobacco, tomato, and wheat which are tolerant to ALS inhibitors (for example sulfonylurea herbicide and imidazolinone herbicides) (See, for example, U.S. Pat. No. 5,013,659, WO 2006060634, U.S. Pat. Nos. 4,761,373, 5,304,732, 6,211,438, 6,211,439, and 6,222,100). In particular, rice tolerant to imidazolinone herbicides is known, and rice and the like having specific mutations in ALS (for example, S653N, S654K, A122T, S653(At)N, S654(At)K, and A122(At)T are known (See, for example, US 2003/0217381, WO 200520673.); barley, sugarcane, rice, corn, tobacco, soybean, cotton, rapeseed, beet, wheat, and potato which are tolerant to HPPD inhibiting herbicides (for example, isoxazole herbicides such as isoxaflutole, triketone herbicides such as sulcotrione and mesotrione, pyrazole herbicides such as pyrazolinate, and diketonitrile which is a degradation product of isoxaflutole) (See, for example, WO 2004/055191, WO 199638567, WO 1997049816, and U.S. Pat. No. 6,791,014).

Examples of plants to which herbicide tolerance is imparted by classical or genomic breeding technique include rice “Clearfield Rice”, wheat “Clearfield Wheat”, sunflower “Clearfield Sunflower”, lentil “Clearfield lentils”, and canola “Clearfield canola” (BASF products) which are tolerant to imidazolinone ALS-inhibiting herbicides such as imazethapyr and imazamox; soybean tolerant to sulffonyl ALS inhibitory herbicides such as thifensulfuronmethyl, “STS soybean”; sethoxydim-tolerant corn tolerant to acetyl-CoA carboxylase (hereinafter, abbreviated as ACCase) inhibitors such as trione oxime herbicides and aryloxyphenoxypropionic acid herbicides, “SR corn”, “Poast Protected (resistered trademark) corn”; sunflower tolerant to, for example, sulfonylurea herbicides such as tribenuron, “ExpressSun (registered trademark)”; rice tolerant to acetyl-CoA carboxylase inhibitors such as quizalofop, “Rrovisia (registered trademark) Rice”; and canola tolerant to photosystem II inhibitors, “Triazinon Tolerant Canola”.

Examples of plants to which herbicide tolerance is imparted by genome editing technique include canola tolerant to sulfonylurea herbicide obtained by Rapid Trait Development System, RTDS (registered trademark), “SU Canola (registered trademark)”. RTDS (registered trademark) corresponds to oligonucleotide-directed mutagenesis of genome editing technique, and is a technique capable of introducing a mutation through Gene Repair Oligonucleotide (GRON), that is, a chimeric oligonucleotide of DNA and RNA without cleaving DNA in a plant. Examples thereof also include corn in which herbicide tolerance and phytic acid content is reduced by deletion of the endogenous gene IPK1 with a zinc finger nuclease (See, for example, Nature 459, 437-441 2009); and rice to which herbicide tolerance is imparted using CRISPR/Cas9 (See, for example, Rice, 7, 5 2014).

Examples of a plant to which herbicide tolerance is imparted by new breeding techniques include non-transgenic soybean scion to which glyphosate tolerance is imparted using Roundup Ready (registered trademark) soybean with glyphosate tolerance as rootstock, as an example of imparting properties of a GM rootstock to a scion, which is a breeding technique in which grafting is used (See Weed Technology 27: 412-416 2013).

Examples of the non-agricultural land to which the method of the present invention can be applied include a railway, a factory site, an area under a pipeline, a roadside, a park, and a bank. The agricultural land is not particularly limited as long as it is a place where plants such as agricultural crops are cultivated, and examples thereof include a field, a paddy field, a raising seedling tray, a nursery box, and a nursery.

In the method of the present invention, the present compound is usually mixed with a carrier such as a solid carrier and a liquid carrier, and further formulated by addition of an auxiliary agent for formulation such as a surfactant as necessary. Preferable formulation types when the present compound is formulated are soluble liquids, soluble granules, aqueous liquid suspensions, oil-based liquid suspensions, wettable powders, water dispersible granules, granules, aqueous emulsions, oil-based emulsions, and emulsifiable concentrates. An aqueous liquid formulation is more preferable. Using a formulation containing the present compound as a single component as an active ingredient alone, it can be combined with a formulation containing at least one different herbicide as an active ingredient and applied. A formulation containing the present combination as active ingredients can be also used. Further, a formulation containing the present combination as active ingredients and a formulation containing a herbicide different from the herbicides contained in the former formulation as an active ingredient can be combined and applied. The ‘combined application’ can be changed to sequential application, and the sequential order is not particularly limited. The percentage of the active ingredient (the present compound or the total of the present combination) in the formulation is usually in the range of 0.01 to 90 wt %, preferably in the range of 1 to 80 wt %.

Examples of the method of applying the present combination include a method of spraying the present combination to a soil in a non-agricultural land or an agricultural land (soil treatment), and a method of spraying the present compound to growing weeds (foliar treatment). In the case of the sequential application, the application may be consist of soil treatment and foliar treatment. Usually, a formulation containing the present compound is mixed with water to prepare a spray liquid, and the spray liquid is sprayed using an applicator equipped with a nozzle. Though the amount of the spray liquid is not particularly limited, it is usually 50 to 1000 L/ha, preferably 100 to 500 L/ha, and more preferably 140 to 300 L/ha.

The application rate of the present compound is usually 100 to 2000 g per 10,000 m², preferably 200 to 1600 g per 10,000 m², more preferably 300 to 1200 g per 10,000 m², and further preferably 400 to 900 g per 10,000 m². When the present compound is applied, an adjuvant can be combined and applied. The type of the adjuvant is not particularly limited, and examples thereof include oil adjuvants such as Agri-Dex and MSO, nonionic adjuvants such as Induce (ester or ether of polyoxyethylene), anionic adjuvants such as gramine S (substituted sulfonate), cationic adjuvants such as Genamin T 200 BM (polyoxythylene amine), and organic silicon adjuvants such as Silwett L77. Further, a drift reducing agent such as Intact (polyethylene glycol) can be combined and applied.

Though the pH and hardness of the spray liquid are not particularly limited, the pH is usually in the range of pH 5 to 9, and the hardness is usually in the range of 0 to 500.

Though the time period for applying the present compound is not particularly limited, it is usually in the range of 5 AM to 9 PM, and the photon flux density is usually 10 to 2500 micromol/m²/sec.

Though the spraying pressure at the time of applying the present compound is not particularly limited, it is usually 30 to 120 PSI, and preferably 40 to 80 PSI.

The nozzle specified for the application of the present compound in the method of the present invention can be a flat fan nozzle or a drift reducing nozzle. Examples of the flat fan nozzle include TeeJet 110 series and XR TeeJet 110 series manufactured by TeeJet Technologies. The volume median diameter of droplets discharged from these nozzles is usually less than 430 microns at normal spray pressure, which is usually 30 to 120 PSI. The drift reducing nozzle is a nozzle in which drift is reduced as compared with a flat fan nozzle and which is called an air induction nozzle or a pre-orifice nozzle. The volume median diameter of droplets discharged from the drift reducing nozzle is usually 430 microns or more.

The air induction nozzle is a nozzle that has an air introduction part between an inlet (chemical liquid introduction part) and an outlet (chemical liquid discharge part) of the nozzle, and forms droplets filled with air by mixing air into a chemical liquid. Examples of the air induction nozzle include TDXL11003-D, TDXL11004-D1, TDXL11005-D1, and TDXL11006-D manufactured by Green Leaf Technology, TTI110025, TTI11003, TTI11004, TTI11005, TTI110061, and TTI110081 manufactured by TeeJet Technologies, and ULD120-041, ULD120-051, and ULD120-061 manufactured by Pentair plc. TTI11004 Is particularly desirable.

A pre-orifice nozzle is a nozzle in which an inlet (chemical liquid introduction part) of the nozzle functions as metering orifice, which limits the flow rate of inflow into the nozzle and reduces a pressure in the nozzle, thereby forms large droplets. This almost halves the pressure at the time of discharge as compared with that before introduction. Examples of the pre-orifice nozzle include DR110-10, UR110-05, UR110-06, UR110-08, and UR110-10 manufactured by Wilger Industries Ltd., and 1/4TTJ08 Turf Jet and 1/4TTJ04 Turf Jet manufactured by TeeJet Technologies.

When the method of the present invention is applied to a cultivation area of a plant such as a crop, plant seeds are seeded in the cultivation area by a normal method. In the method of the present invention, the present compound can be applied to a cultivation area before seeding, or the present compound can be applied simultaneously with seeding and/or after seeding. That is, the number of application of the present compound is any of 1 to 3, and in the case of 1, the compound is applied 1 time before seeding, 1 time simultaneously with seeding, or 1 time after seeding. In the case of 2, the present compound is applied 2 times except before seeding, 2 times except simultaneously with seeding, or 2 times except after seeding. In the case of 3, the present compound is applied 1 time before seeding, 1 time simultaneously with seeding, and 1 time after seeding.

When the present compound is applied before seeding, the present compound is usually applied in a period between 50 days before seeding and immediately before seeding, preferably applied in a period between 30 days before seeding and immediately before seeding, more preferably applied in a period between 20 days before seeding and immediately before seeding, or further preferably applied in a period between 10 days before seeding and immediately before seeding.

When the present compound is applied after seeding, the present compound is usually applied immediately after seeding to before flowering. A more preferable application time is between immediately after seeding and before emergence, and between the 1 leaf stage and the 6 leaf stage of the true leaf of the plant.

The case where the present compound is applied simultaneously with seeding is a case where the seeding machine and the applicator are integrated.

In the case where the method of the present invention is applied to a cultivation area of a plant such as a crop, when the plant is cultivated, the seed of the plant can be treated with one or more compound selected from the group consisting of a specific insecticide compound, a nematicide compound, a fungicide compound, and a plant growth regulator compound. Examples thereof include a neonicotinoid compound, a diamide compound, a carbamate compound, an organophosphorus compound, a biological nematicide compound, other insecticide compounds and nematicide compounds, an azole compound, a strobilurin compound, a metalaxyl compound, a SDHI compound, and other fungicide compounds and plant growth regulator compounds.

Examples of the weed species to be controlled by the method of the present invention include, but are not limited to, the following.

Urticaceae weeds: small nettle (Urtica urens)

Polygonaceae weeds: black bindweed (Polygonum convolvulus), pale persicaria (Polygonum lapathifolium), Pennsylvania smartweed (Polygonum pensylvanicum), redshank (Polygonum persicaria), bristly lady's-thumb (Polygonum longisetum), knotgrass (Polygonum aviculare), equal-leaved knotgrass (Polygonum arenastrum), Japanese knotweed (Polygonum cuspidatum), Japanese dock (Rumex japonicus), curly dock (Rumex crispus), blunt-leaved dock (Rumex obtusifolius), common sorrel (Rumex acetosa)

Portulacaceae weeds: common purslane (Portulaca oleracea)

Caryophyllaceae weeds: common chickweed (Stellaria media), water chickweed (Stellaria aquatica), common mouse-ear (Cerastium holosteoides), sticky mouse-ear (Cerastium glomeratum), corn spurrey (Spergula arvensis), five-wound catchfly (Silene gallica)

Molluginaceae weeds: carpetweed (Mollugo verticillata)

Chenopodiaceae weeds: common lambsquarters (Chenopodium album), Indian goose foot (Chenopodium ambrosioides), kochia (Kochia scoparia), spiny saltwort (Salsola kali), Orach (Atriplex spp.)

Amaranthaceae weeds: redroot pigweed (Amaranthus retroflexus), slender amaranth (Amaranthus viridis), livid amaranth (Amaranthus lividus), spiny amaranth (Amaranthus spinosus), smooth pigweed (Amaranthus hybridus), Palmer amaranth (Amaranthus palmeri), green pigweed (Amaranthus patulus), waterhemp (Amaranthus tuberculatus=Amaranthus rudis=Amaranthus tamariscinus), prostrate pigweed (Amaranthus blitoides), large-fruit amaranth (Amaranthus deflexus), mucronate amaranth (Amaranthus quitensis), alligator weed (Alternanthera philoxeroides), sessile alligator weed (Alternanthera sessilis), perrotleaf (Alternanthera tenella)

Papaveraceae weeds: common poppy (Papaver rhoeas), field poppy (Papaver dubium), Mexican prickle poppy (Argemone mexicana)

Brassicaceae weeds: wild radish (Raphanus raphanistrum), radish (Raphanus sativus), wild mustard (Sinapis arvensis), shepherd's purse (Capsella bursa-pastoris), white mustard (Brassica juncea), oilseed rape (Brassica napus), pinnate tansy mustard (Descurainia pinnata), marsh yellowcress (Rorippa islandica), yellow fieldcress (Rorippa sylvestris), field pennycress (Thlaspi arvense), turnip weed (Myagrum rugosum), Virginia pepperweed (Lepidium virginicum), slender wartcress (Coronopus didymus)

Capparaceae weeds: African cabbage (Cleome affinis)

Fabaceae weeds: Indian joint vetch (Aeschynomene indica), zigzag joint vetch (Aeschynomene rudis), hemp sesbania (Sesbania exaltata), sickle pod (Cassia obtusifolia), coffee senna (Cassia occidentalis), Florida beggar weed (Desmodium tortuosum), wild groundnut (Desmodium adscendens), Illinois tick trefoil (Desmodium illinoense), white clover (Trifolium repens), kudzu (Pueraria lobata), narrowleaf vetch (Vicia angustifolia), hairy indigo (Indigofera hirsuta), Indigofera truxillensis, common cowpea (Vigna sinensis)

Oxalidaceae weeds: creeping wood sorrel (Oxalis corniculata), European wood sorrel (Oxalis stricta), purple shamrock (Oxalis oxyptera)

Geraniaceae weeds: Carolina geranium (Geranium carolinense), common storksbill (Erodium cicutarium)

Euphorbiaceae weeds: sun spurge (Euphorbia helioscopia), annual spurge (Euphorbia maculata), prostrate spurge (Euphorbia humistrata), Hungarian spurge (Euphorbia esula), wild poinsettia (Euphorbia heterophylla), hyssop-leaf sandmat (Euphorbia brasiliensis), Asian copperleaf (Acalypha australis), tropic croton (Croton glandulosus), lobed croton (Croton lobatus), long-stalked phyllanthus (Phyllanthus corcovadensis), castor bean (Ricinus communis)

Malvaceae weeds: velvetleaf (Abutilon theophrasti), arrow-leaf sida (Sida rhombiforia), heart-leaf sida (Sida cordifolia), prickly sida (Sida spinosa), Sida glaziovii, Sida santaremnensis, bladder weed (Hibiscus trionum), spurred anoda (Anoda cristata), spine-seeded false-mallow (Malvastrum coromandelianum)

Onagraceae weeds: Ludwigia epilobioides, long-fruited primrose willow (Ludwigia octovalvis), winged water primrose (Ludwigia decurre), common evening-primrose (Oenothera biennis), cutleaf evening-primrose (Oenothera laciniata)

Sterculiaceae weeds: Florida waltheria (Waltheria indica)

Violaceae weeds: field violet; Viola arvensis, wild violet; Viola tricolor

Cucurbitaceae weeds: bur cucumber (Sicyos angulatus), wild cucumber (Echinocystis lobata), bitter balsam apple (Momordica charantia)

Lythraceae weeds: Ammannia multiflora, eared redstem (Ammannia auriculata), scarlet toothcup (Ammannia coccinea), purple loosestrife (Lythrum salicaria), Indian toothcup (Rotala indica)

Elatinaceae weeds: three-stamen waterwort (Elatine triandra), California waterwort (Elatine californica)

Apiaceae weeds: Chinese celery (Oenanthe javanica), wild carrot (Daucus carota), carrot fern (Conium maculatum)

Araliaceae weeds: lawn pennywort (Hydrocotyle sibthorpioides), floating pennywort (Hydrocotyle ranunculoides)

Ceratophyllaceae weeds: common hornwort (Ceratophyllum demersum)

Cabombaceae weeds: Carolina fanwort (Cabomba caroliniana)

Haloragaceae weeds: Brazilian water milfoil (Myriophyllum aquaticum), whorled water milfoil (Myriophyllum verticillatum), water milfoils (Myriophyllum spicatum, Myriophyllum heterophyllum, etc.)

Sapindaceae weeds: heartseed (Cardiospermum halicacabum)

Primulaceae weeds: scarlet pimpernel (Anagallis arvensis)

Asclepiadaceae weeds: common milkweed (Asclepias syriaca), honeyvine milkweed (Ampelamus albidus)

Rubiaceae weeds: catchweed bedstraw (Galium aparine), Galium spurium var. echinospermon, broadleaf buttonweed (Spermacoce latifolia), Brazil calla lily (Richardia brasiliensis), broadleaf buttonweed (Borreria alata)

Convolvulaceae weeds: Japanese morning glory (Ipomoea nil), ivy-leaf morning glory (Ipomoea hederacea), tall morning glory (Ipomoea purpurea), entire-leaf morning glory (Ipomoea hederacea var. integriuscula), pitted morning glory (Ipomoea lacunosa), three-lobe morning glory (Ipomoea triloba), blue morning glory (Ipomoea acuminata), scarlet morning glory (Ipomoea hederifolia), red morning glory (Ipomoea coccinea), cypress-vine morning glory (Ipomoea quamoclit), Ipomoea grandifolia, Ipomoea aristolochiafolia, Cairo morning glory (Ipomoea cairica), field bindweed (Convolvulus arvensis), Japanese false bindweed (Calystegia hederacea), Japanese bindweed (Calystegia japonica), ivy woodrose (Merremia hedeacea), hairy woodrose (Merremia aegyptia), roadside woodrose (Merremia cissoides), small-flower morning glory (Jacquemontia tamnifolia)

Boraginaceae weeds: field forget-me-not (Myosotis arvensis)

Lamiaceae weeds: purple deadnettle (Lamium purpureum), common henbit (Lamium amplexicaule), lion's ear (Leonotis nepetaefolia), wild spikenard (Hyptis suaveolens), Hyptis lophanta, Siberian motherwort (Leonurus sibiricus), field-nettle betony (Stachys arvensis)

Solanaceae weeds: jimsonweed (Datura stramonium), black nightshade (Solanum nigrum), American black nightshade (Solanum americanum), eastern black nightshade (Solanum ptycanthum), hairy nightshade (Solanum sarrachoides), buffalo bur (Solanum rostratum), soda-apple nightshade (Solanum aculeatissimum), sticky nightshade (Solanum sisymbriifolium), horse nettle (Solanum carolinense), cutleaf groundcherry (Physalis angulata), smooth groundcherry (Physalis subglabrata), apple of Peru (Nicandra physaloides)

Scrophulariaceae weeds: ivyleaf speedwell (Veronica hederaefolia), common speedwell (Veronica persica), corn speedwell (Veronica arvensis), common false pimpernel (Lindernia procumbens), false pimpernel (Lindernia dubia), Lindernia angustifolia, round-leaf water hyssop (Bacopa rotundifolia), dopatrium (Dopatrium junceum), Gratiola japonica,

Plantaginaceae weeds: Asiatic plantain (Plantago asiatica), narrow-leaved plantain (Plantago lanceolata), broadleaf plantain (Plantago major), marsh water starwort (Callitriche palustris)

Asteraceae weeds: common cocklebur (Xanthium pensylvanicum), large cocklebur (Xanthium occidentale), Canada cocklebur (Xanthium italicum), common sunflower (Helianthus annuus), wild chamomile (Matricaria chamomilla), scentless chamomile (Matricaria perforata), corn marigold (Chrysanthemum segetum), rayless mayweed (Matricaria matricarioides), Japanese mugwort (Artemisia princeps), common mugwort (Artemisia vulgaris), Chinese mugwort (Artemisia verlotorum), tall goldenrod (Solidago altissima), common dandelion (Taraxacum officinale), hairy galinsoga (Galinsoga ciliata), small-flower galinsoga (Galinsoga parviflora), common groundsel (Senecio vulgaris), flower-of-souls (Senecio brasiliensis), Senecio grisebachii, fleabane (Conyza bonariensis), Guernsey fleabane (Conyza sumatrensis), marestail (Conyza canadensis), common ragweed (Ambrosia artemisiaefolia), giant ragweed (Ambrosia trifida), three-cleft bur-marigold (Bidens tripartita), hairy beggarticks (Bidens pilosa), common beggarticks (Bidens frondosa), greater beggarticks (Bidens subalternans), Canada thistle (Cirsium arvense), black thistle (Cirsium vulgare), blessed milkthistle (Silybum marianum), musk thistle (Carduus nutans), prickly lettuce (Lactuca serriola), annual sowthistle (Sonchus oleraceus), spiny sowthistle (Sonchus asper), beach creeping oxeye (Wedelia glauca), perfoliate blackfoot (Melampodium perfoliatum), red tasselflower (Emilia sonchifolia), wild marigold (Tagetes minuta), para cress (Blainvillea latifolia), coat buttons (Tridax procumbens), Bolivian coriander (Porophyllum ruderale), Paraguay starbur (Acanthospermum australe), bristly starbur (Acanthospermum hispidum), balloon vine (Cardiospermum halicacabum), tropic ageratum (Ageratum conyzoides), common boneset (Eupatorium perfoliatum), American false daisy (Eclipta alba), fireweed (Erechtites hieracifolia), American cudweed (Gamochaeta spicata), linear-leaf cudweed (Gnaphalium spicatum), Jaegeria hirta, ragweed parthenium (Parthenium hysterophorus), small yellow crownbeard (Siegesbeckia orientalis), lawn burweed (Soliva sessilis), white eclipta (Eclipta prostrata), American false daisy (Eclipta alba), spreading sneezeweed (Centipeda minima)

Alismataceae weeds: dwarf arrowhead (Sagittaria pygmaea), threeleaf arrowhead (Sagittaria trifolia), arrowhead (Sagittaria sagittifolia), giant arrowhead (Sagittaria montevidensis), Sagittaria aginashi, channelled water plantain (Alisma canaliculatum), common water plantain (Alisma plantago-aquatica)

Limnocharitaceae weeds: Sawah flowering rush (Limnocharis flava)

Hydrocharitaceae weeds: American frogbit (Limnobium spongia), Florida elodea (Hydrilla verticillata), common water nymph (Najas guadalupensis)

Araceae weeds: Nile cabbage (Pistia stratiotes)

Lemnaceae weeds: three-nerved duckweed (Lemna aoukikusa), common duckmeat (Spirodela polyrhiza), Wolffia spp.

Potamogetonaceae weeds: roundleaf pondweed (Potamogeton distinctus), pondweeds (Potamogeton crispus, Potamogeton illinoensis, Stuckenia pectinata, etc.)

Liliaceae weeds: wild onion (Allium canadense), wild garlic (Allium vineale), Chinese garlic (Allium macrostemon)

Pontederiaceae weeds: common water hyacinth (Eichhornia crassipes), blue mud plantain (Heteranthera limosa), Monochoria korsakowii, heartshape false pickerelweed (Monochoria vaginalis)

Commelinaceae weeds: common dayflower (Commelina communis), tropical spiderwort (Commelina bengharensis), erect dayflower (Commelina erecta), Asian spiderwort (Murdannia keisak)

Poaceae weeds: common barnyardgrass (Echinochloa crus-galli), early barnyardgrass (Echinochloa oryzicola), barnyard grass (Echinochloa crus-galli var formosensis), late watergrass (Echinochloa oryzoides), jungle rice (Echinochloa colonum), Gulf cockspur (Echinochloa crus-pavonis), green foxtail (Setaria viridis), giant foxtail (Setaria faberi), yellow foxtail (Setaria glauca), knotroot foxtail (Setaria geniculata), southern crabgrass (Digitaria ciliaris), large crabgrass (Digitaria sanguinalis), Jamaican crabgrass (Digitaria horizontalis), sourgrass (Digitaria insularis), goosegrass (Eleusine indica), annual bluegrass (Poa annua), rough-stalked meadowgrass (Poa trivialis), Kentucky bluegrass (Poa pratensis), short-awn foxtail (Alospecurus aequalis), blackgrass (Alopecurus myosuroides), wild oat (Avena fatua), Johnsongrass (Sorghum halepense), shataken (grain sorghum; Sorghum vulgare), quackgrass (Agropyron repens), Italian ryegrass (Lolium multiflorum), perennial ryegrass (Lolium perenne), bomugi (rigid ryegrass; Lolium rigidum), rescue brome (Bromus catharticus), downy brome (Bromus tectorum), Japanese brome grass (Bromus japonicus), cheat (Bromus secalinus), cheatgrass (Bromus tectorum), foxtail barley (Hordeum jubatum), jointed goatgrass (Aegilops cylindrica), reed canarygrass (Phalaris arundinacea), little-seed canary grass (Phalaris minor), silky bentgrass (Apera spica-venti), fall panicum (Panicum dichotomiflorum), Texas panicum (Panicum texanum), guineagrass (Panicum maximum), broadleaf signalgrass (Brachiaria platyphylla), Congo signal grass (Brachiaria ruziziensis), Alexander grass (Brachiaria plantaginea), Surinam grass (Brachiaria decumbens), palisade grass (Brachiaria brizantha), creeping signalgrass (Brachiaria humidicola), southern sandbur (Cenchrus echinatus), field sandbur (Cenchrus pauciflorus), woolly cupgrass (Eriochloa villosa), feathery pennisetum (Pennisetum setosum), Rhodes grass (Chloris gayana), feathertop Rhodes grass (Chlorisvirgata), India lovegrass (Eragrostis pilosa), Natal grass (Rhynchelitrum repens), crowfoot grass (Dactyloctenium aegyptium), winkle grass (Ischaemum rugosum), swamp millet (Isachne globosa), common rice (Oryza sativa), bahiagrass (Paspalum notatum), coastal sand paspalum (Paspalum maritimum), mercergrass (Paspalum distichum), kikuyugrass (Pennisetum clandestinum), West Indies pennisetum (Pennisetum setosum), itch grass (Rottboellia cochinchinensis), Asian sprangletop (Leptochloa chinensis), salt-meadow grass (Leptochloa fascicularis), Christmas-tree grass (Leptochloa filiformis), Amazon sprangletop (Leptochloa panicoides), Japanese cutgrass (Leersia japonica), Leersia sayanuka, cutgrass (Leersia oryzoides), Glyceria leptorrhiza, sharpscale mannagrass (Glyceria acutiflora), great watergrass (Glyceria maxima), redtop (Agrostis gigantea), carpet bent (Agrostis stolonifera), Bermuda grass (Cynodon dactylon), cocks foot (Dactylis glomerata), centipede grass (Eremochloa ophiuroides), tall fescue (Festuca arundinacea), red fescue (Festuca rubra), lalang (Imperata cylindrica), Chinese fairy grass (Miscanthus sinensis), switchgrass (Panicum virgatum), Japanese lawngrass (Zoysia japonica)

Cyperaceae weeds: Asian flatsedge (Cyperus microiria), rice flatsedge (Cyperus iria), hedgehog cyperus (Cyperus compressus), small-flowered nutsedge (Cyperus difformis), lax-flat sedge (Cyperus flaccidus), Cyperus globosus, Cyperus nipponics, fragrant flatsedge (Cyperus odoratus), mountain nutsedge (Cyperus serotinus), purple nutsedge (Cyperus rotundus), yellow nutsedge (Cyperus esculentus), pasture spike sedge (Kyllinga gracillima), green kyllinga (Kyllinga brevifolia), grasslike fimbristylis (Fimbristylis miliacea), annual fringerush (Fimbristylis dichotoma), slender spikerush (Eleocharis acicularis), Eleocharis kuroguwai, Japanese bulrush (Schoenoplectiella hotarui), hardstem bulrush (Schoenoplectiella juncoides), Schoenoplectiella wallichii, rough-seed bulrush (Schoenoplectiella mucronatus), Schoenoplectiella triangulatus, Schoenoplectiella nipponicus, triangular club-rush (Schoenoplectiella triqueter), Bolboschoenus koshevnikovii, river bulrush (Bolboschoenus fluviatilis)

Equisetaceae weeds: field horsetail (Equisetum arvense), marsh horsetail (Equisetum palustre)

Salviniaceae weeds: floating fern (Salvinia natans)

Azollaceae weeds: Japanese mosquitofern (Azolla japonica), feathered mosquito fern (Azolla imbricata)

Marsileaceae weeds: clover fern (Marsilea quadrifolia)

Other: Filamentous algae (Pithophora, Cladophora), Bryophyta, Marchantiophyta, Anthocerotophyta, Cyanobacteria, Pteridophyta, sucker of perennial crop (pome fruits, stone fruits, berry fruits, nuts, citrus fruits, hops, grapes, etc.)

The resistance factor of the dicamba-resistant weed that can be controlled by the method of the present invention can be a factor of a mutation at a target site (target site mutation) or a factor other than a target site mutation (non-target site mutation). Examples of the non-target site mutation include enhanced metabolism, absorption failure, transfer failure, and excretion outside the system. Examples of the factor of the enhanced metabolism include an increase in the activity of a metabolic enzyme such as cytochrome P450 monooxygenase (CYP), allyl acylamidase (AAA), esterase, and glutathione S transferase (GST). Examples of the excretion outside the system include transport to vacuoles by an ABC transporter. For the target site mutation, dicamba-resistant kochia having a mutation that causes Gly-Asn in the degron region of the AUX/IAA gene is known (Non-Patent Document 1), and for the non-target site mutation, dicamba-resistant smooth pigweed for which involvement of CYP is suggested is known (Non-Patent Document 2). However, examples of the target site mutation and the non-target site mutation are not limited thereto. For example, redroot pigweed, smooth pigweed, Palmer amaranth, waterhemp, marestail, common ragweed, wild radish and the like that have become dicamba-resistant by having a similar target site mutation are effectively controlled, and similarly, kochia, redroot pigweed, Palmer amaranth, waterhemp, marestail, common ragweed, wild radish and the like that have become dicamba-resistant due to the involvement of CYP are also effectively controlled. Kochia, redroot pigweed, smooth pigweed, Palmer amaranth, waterhemp, marestail, common ragweed, wild radish that have become dicamba-resistant due to other target site mutations or other non-target site mutations are also effectively controlled.

When, in the cultivation area of the crop A, another crop B unintentionally grows spontaneously, the crop that grows spontaneously is called a volunteer crop B, which is also a control target as one type of a weed. Volunteer dicamba-tolerant soybean and volunteer dicamba-tolerant cotton are also effectively controlled as one type of a dicamba-resistant weed by the method of the present invention. Examples of the case where the method of the present invention is the method in a cultivation area of a crop, the crop A is a dicamba-tolerant plant, and the volunteer crop B is controlled include a case where the crop B growing spontaneously in the cultivation area of the crop A is controlled before the crop A is seeded, a case where the crop B is simultaneously and sympatrically present with the crop A, and the method of the present invention is applied only to the crop B, and a case where the crop B is simultaneously and sympatrically present with the crop A, and only the crop A is tolerant to at least one different herbicide.

The dicamba-resistant weed that can be controlled by the method of the present invention can further have a trait of resistance to other herbicides due to a target site mutation or a similar non-target site mutation. Specific examples of other herbicides will be given below by group.

ALS Inhibitory Herbicide Resistance

For the target site mutation, weeds having a mutation that causes one or more of the following amino acid substitutions in the ALS gene are included. Ala122Thr, Ala122Val, Ala122Tyr, Pro197Ser, Pro197His, Pro197Thr, Pro197Arg, Pro197Leu, Pro197Gln, Pro197Ala, Pro197Ile, Ala205Val, Ala205Phe, Asp376Glu, Asp376Asn, Arg377His, Trp574Leu, Trp574Gly, Trp574Met, Ser653Thr, Ser653Thr, Ser653Asn, Ser635Ile, Gly654Glu, and Gly645Asp. ALS inhibitor-resistant redroot pigweed, smooth pigweed, Palmer amaranth, waterhemp, kochia and the like having these target site mutations are effectively controlled even when they are dicamba-resistant. For the non-target site mutation, even when a weed that has become resistant to an ALS inhibitor due to the involvement of CYP or GST is dicamba-resistant, it is effectively controlled.

ACCase Inhibitor Resistance

For the target site mutation, weeds having a mutation that causes one or more of the following amino acid substitutions in the ACCase are included. Ile1781Leu, Ile1781Val, Ile1781Thr, Trp1999Cys, Trp1999Leu, Ala2004Val, Trp2027Cys, Ile2041Asn, Ile2041Val, Asp2078Gly, and Cys2088Arg. Even when an ACCase resistant weed having these target site mutations is dicamba-resistant, it is effectively controlled. For the non-target site mutation, even when a weed that has become resistant to an ACCase inhibitor due to the involvement of CYP or GST is dicamba-resistant, it is effectively controlled.

Glyphosate Resistance

For the target site mutation, weeds having a mutation that causes one or more of the following amino acid substitutions in the EPSPS gene are included. Thr102Ile, Pro106Ser, Pro106Ala, Pro106Leu. Similarly, examples of a case of glyphosate resistance by a target site include increase in the copy number of the EPSPS gene. Glyphosate-resistant Palmer amaranth, waterhemp, kochia and the like having these mutations are effectively controlled even when they are dicamba-resistant. For the non-target site mutation, glyphosate-resistant marestail, guernsey fleabane, fleabane and the like in which an ABC transporter is involved are effectively controlled even when they are dicamba-resistant. Further, for the non-target site mutation, jungle rice having reduced sensitivity to glyphosate due to the increase in expression of aldoketoreductase is known (Plant Physiology 181, 1519-1534), and it is effectively controlled even when it is dicamba-resistant.

PPO Inhibitor Resistance

For the target site mutation, weeds having a mutation that causes one or more of the following amino acid substitutions in the PPO gene are known as a mutation resistant to carfentrazone-ethyl, fomesafen, or lactofen, or is predicted to become a resistance mutation. Arg128Leu, Arg128Met, Arg128Gly, Arg128His, Arg128Ala, Arg128Cys, Arg128Glu, Arg128Ile, Arg128Lys, Arg128Asn, Arg128Gln, Arg128Ser, Arg128Thr, Arg128Val, Arg128Tyr, Gly210 deletion, Ala210 deletion, Gly210Thr, Ala210Thr, G211 deletion, Gly114G1u, Ser149Ile, Gly399Ala (The amino acid numbers are all standardized with the sequence of PPO2 from Palmer amaranth (Amaranthus palmeri)). PPO1 and PPO2 are usually present in PPO of a weed. The mutation can be present in either or both of PPO1 and PPO2. The case where the mutation is in PPO2 is preferable. For example, Arg128Met means that there is a mutation in the 128th amino acid. Arg128Leu is known as Arg98Leu in PPO2 of common ragweed (Weed Science 60, 335-344), Arg128Met is known in PPO2 of a Palmer amaranth (Pest Management Science 73, 1559-1563), Arg128Gly is known in PPO2 of a Palmer amaranth (Pest Management Science 73, 1559-1563) and PPO2 of waterhemp (Pest Management Science, doi: 10.1002/ps. 5445), Arg128Ile and Arg128Lys are known in PPO2 of waterhemp (Pest Management Science, doi: 10.1002/ps. 5445), Arg128His is known in PPO2 of the bomugi as Arg132His (WSSA annual meeting, 2018), Gly114Glu, Ser149Ile, and Gly399Ala are known in PPO2 of a Palmer amaranth (Frontiers in Plant Science 10, Article 568), and Ala210Thr is known in PPO1 of goosegrass as Ala212Thr (WSSA annual meeting, 2019). PPO inhibitor-resistant weeds having these target site mutations are effectively controlled even when they are dicamba-resistant. However, the weeds that are effectively controlled are not limited to these. That is, other PPO inhibitor-resistant weeds having the amino acid mutations are similarly controlled even when they are dicamba-resistant. Not only Palmer amaranth having a mutation of Arg128Leu, Arg128Met, Arg128Gly, Arg128His, Arg128Ala, Arg128Cys, Arg128Glu, Arg128Ile, Arg128Lys, Arg128Asn, Arg128Gln, Arg128Ser, Arg128Thr, Arg128Val, Arg128Tyr, Gly210 deletion, Ala210 deletion, Gly210Thr, Ala210Thr, G211 deletion, Gly114Glu, Ser149Ile, or Gly399Ala in PPO1 or PPO2, but also waterhemp having the same mutation, common ragweed having the same mutation, wild poinsettia having the same mutation and the like are effectively controlled even when they are dicamba-resistant. For the non-target site mutation, as waterhemp or Palmer amaranth that has become resistant to a PPO inhibitor due to the involvement of CYP or GST, waterhemp that has become resistant to carfentrazone-ethyl and the like are known (PLOS ONE, doi: 10.1371/journal.pone.0215431), and these are effectively controlled even when they are dicamba-resistant.

2,4-D resistance: for the non-target site mutation, waterhemp, Palmer amaranth and the like that have become 2,4-D-resistant due to the involvement of CYP are effectively controlled even when they are dicamba-resistant. They are effectively controlled even when GST is involved.

HPPD inhibitor resistance: for the non-target site mutation, waterhemp, Palmer amaranth and the like that have become resistant to HPPD inhibitors due to the involvement of CYP or GST are effectively controlled even when they are dicamba-resistant.

Photosystem II inhibitor resistance: for the target site mutation, weeds having a mutation that causes one or more of the following amino acid substitutions in the psbA gene are included. Val219Ile, Ser264Gly, Ser264Ala, Phe274Val. Photosystem II inhibitor-resistant Palmer amaranth and waterhemp having these target site mutations are effectively controlled even when they are dicamba-resistant. For the non-target site mutation, Palmer amaranth, waterhemp and the like that are resistant to photosystem II inhibitors due to the involvement of CYP, GST, or AAA are effectively controlled even when they are dicamba-resistant.

Even when the dicamba-resistant weed is a resistant weed having resistance to (having stacked resistance to) two or more groups (arbitrarily selected two groups, arbitrarily selected three groups, arbitrarily selected four groups, arbitrarily selected five groups, arbitrarily selected six groups, or arbitrarily selected seven groups) of the above-mentioned groups, the dicamba-resistant weed is effectively controlled. As an example, waterhemp resistant to all of photosystem II inhibitors, HPPD inhibitors, 2,4-D, PPO inhibitors, glyphosate, and ALS inhibitors is known, and, this is effectively controlled even when it is dicamba-resistant. The above-mentioned stack can be based on a combination of the target site mutations, a combination of the non-target site mutations, or a combination of the target site mutations and the non-target site mutations.

In the method of the present invention, the present combination can be used in combination with one or more plant growth regulators, and safeners. In the present invention, the ‘use in combination’ includes tank mix, premix, and sequential application, and the sequential order in the case of sequential application is not particularly limited.

Examples of the herbicide, plant growth regulator, and safener that can be used in combination with the present compound include the following.

Safener: allidochlor, benoxacor, cloquintocet, cloquintocet-mexyl, cyometrinil, cyprosulfamide, dichlormid, dicyclonone, dimepiperate, disulfoton, daiymuron, fenchlorazole, fenchlorazole-ethyl, fenclorim, flurazole, furilazole, fluxofenim, hexim, isoxadifen, isoxadifen-ethyl, mecoprop, mefenpyr, mefenpyr-ethyl, mefenpyr-diethyl, mephenate, metcamifen, oxabetrinil, 1,8-naphthalic anhydride, 1,8-octamethylene diamine, AD-67 (4-(dichloroacetyl)-1-oxa-4-azaspiro[4.5]decane), MCPA (2-(4-chloro-2-methylphenoxy) acetic acid), CL-304415 (4-carboxy-3,4-dihydro-2H-1-benzopyran-4-acetic acid), CSB (1-bromo-4-[(chloromethyl)sulfonyl]benzene), DKA-24 (2,2-dichloro-N-[2-oxo-2-(2-propenylamino)ethyl]-N-(2-propenyl)acetamide), MG191 (2-(dichloromethyl)-2-methyl-1,3-dioxolane), MG-838 (2-propenyl 1-oxa-4-azaspiro[4.5]decane-4-carbodithioate), PPG-1292 (2,2-dichloro-N-(1,3-dioxan-2-ylmethyl)-N-(2-propenyl)acetamide), R-28725 (3-(dichloroacetyl)-2,2-dimethyl-1,3-oxazolidine), R-29148 (3-(dichloroacetyl)-2,2,5-trimethyl-1,3-oxazolidine), TI-35 (1-(dichloroacetyl)azepane).

Plant growth regulator: hymexazol, paclobutrazol, uniconazole, uniconazole-P, inabenfide, prohexadione-calcium, 1-methylcyclopropene, trinexapac, and trinexapac-ethyl.

As the herbicide that can be used in combination with the present compound in the method of the present invention, saflufenacil, trifludimoxazin, glyphosate potassium salt, glyphosate guanidine salt, glyphosate dimethylamine salt, glyphosate monoethanolamine salt, glyphosate isopropyl ammonium salt, dimethenamide P, imazetapyl ammonium salt, pyroxasulfone, mesotrione, and isoxaflutole are particularly preferable.

In the method of the present invention, the safener that can be used in combination with the present compound is particularly preferably cyprosulfamide, benoxacol, dichloramide, furilazole, or isoxadifenethyl.

In the cultivation of crops in the present invention, plant nutritional management in general crop cultivation can be performed. The fertilization system can be one based on Precision Agriculture or can be a conventional uniform system. Nitrogen-fixing bacteria and mycorrhizal fungi can also be inoculated by seed treatment.

### EXAMPLES

Hereinafter, the present invention will be described with reference to Examples, but the present invention is not limited to these Examples.

First, evaluation criteria of herbicidal efficacy and phytotoxicity to crops shown in the following Examples are shown.

### Herbicidal Efficacy and Phytotoxicity to Crops

For the evaluation of the herbicidal efficacy, the test weeds are classified into 0 to 100 as follows: the test weed having no or almost no difference in the state of emergence or growth at the time of the investigation as compared with the non-treated weed is classified into “0”, and the test plant that has completely died or has complete suppression of emergence or growth is classified into “100”.

For the evaluation of phytotoxicity to crops, when little phytotoxicity is observed, the evaluation is “harmless”, when slight phytotoxicity is observed, the evaluation is “small”, when moderate phytotoxicity is observed, the evaluation is “moderate”, and when strong phytotoxicity is observed, the evaluation is “large”.

### Example 1

In a plastic pot, dicamba-resistant kochia based on a target site mutation having a Gly-Asn mutation in the Degron region of the AUX/IAA gene, dicamba-resistant smooth pigweed based on a non-target site mutation in which CYP is involved, and volunteer dicamba-tolerant soybean are seeded. Then, cultivation is performed in a greenhouse, and 28 days after seeding, foliar treatment is performed with 12.8 fluid ounce/acre (560 g/ha as dicamba) of Engenia (dicamba BAPMA salt) and 1.4 weight ounce/acre (24.5 g/ha as chlorimuron-ethyl) of Classic (chlorimuron-ethyl). The spray liquid amount is 200 L/ha. After 14 days, an effective effect on the weeds is confirmed.

### Example 2

The same procedures as in Example 1 are performed except that the kochia is changed to waterhemp, the smooth pigweed is changed to Palmer amaranth, and the volunteer dicamba-tolerant soybean is changed to volunteer dicamba-tolerant cotton.

### Examples 3 to 4

The same procedures as in Examples 1 to 2 are performed except that 1.4 weight ounce/acre of Classic is changed to 6 fluid ounce/acre (52 g/ha as clethodim) of Select Max.

### Examples 5 to 6

The same procedures as in Examples 1 to 2 are performed except that 1.4 weight ounce/acre of Classic is changed to 2.5 weight ounce/acre (89 g/ha as flumioxazin) of Valor SX.

### Examples 7 to 8

The same procedures as in Examples 1 to 2 are performed except that 1.4 weight ounce/acre of Classic is changed to 6 fluid ounce/acre (105 g/ha as isoxaflutole) of Balance Flexx.

### Examples 9 to 10

The same procedures as in Examples 1 to 2 are performed except that 1.4 weight ounce/acre of Classic is changed to 300 g/ha of fluridone.

### Examples 11 to 12

The same procedures as in Examples 1 to 2 are performed except that 1.4 weight ounce/acre of Classic is changed to 1 pound/acre (840 g/ha as metribuzin) of Sencor 75DF.

### Examples 13 to 14

The same procedures as in Examples 1 to 2 are performed except that 1.4 weight ounce/acre of Classic is changed to 2 weight ounce/acre (119 g/ha as pyroxasulfone) of Zidua.

### Examples 15 to 16

The same procedures as in Examples 1 to 2 are performed except that 1.4 weight ounce/acre of Classic is changed to 4 pint/acre (2130 g/ha as pendimethalin) of Prowl H2O.

### Examples 17 to 18

The same procedures as in Examples 1 to 2 are performed except that 1.4 weight ounce/acre of Classic is changed to 32 fluid ounce/acre (1543 g/ha as glyphosate-potassium salt) of Roundup PowerMax.

### Examples 19 to 20

The same procedures as in Examples 1 to 2 are performed except that 1.4 weight ounce/acre of Classic is changed to 43 fluid ounce/acre (881 g/ha as glufosinate-ammonium salt) of Liberty.

### Examples 21 to 22

The same procedures as in Examples 1 to 2 are performed except that 1.4 weight ounce/acre of Classic is changed to 100 g/ha of cinmethylin.

### INDUSTRIAL APPLICABILITY

According to the method for controlling a weed of the present invention, weeds can be efficiently controlled.

1. A method for controlling a dicamba-resistant weed, comprising:
applying dicamba or a salt thereof and at least one different herbicide to the dicamba-resistant weed or a habitat of the dicamba-resistant weed.

2. The method according to claim 1, wherein the at least one different herbicide is selected from the group consisting of the following B-1 to B-11:
B-1 acetolactate synthase inhibitors;
B-2 acetyl-CoA carboxylase inhibitors;
B-3 protoporphyrinogen IX oxidase inhibitors;
B-4 4-hydrophenylpyruvate dioxygenase inhibitors;
B-5 phytoene desaturase inhibitors;
B-6 photosystem II inhibitors;
B-7 very long chain fatty acid synthesis inhibitors;
B-8 microtubule formation inhibitors;
B-9 enolpyruvylshikimate 3-phosphate synthase inhibitors;
B-10 glutamine synthase inhibitors; and
B-11 other herbicides;
(including salts or derivatives thereof).

3. The method according to claim 1, wherein the habitat of the dicamba-resistant weed is a cultivation area of a crop.

4. The method according to claim 3, wherein the crop is one selected from the group consisting of soybean, corn, cotton, rapeseed, rice, wheat, barley, sugarcane, sugarbeet, sorghum, and sunflower.

5. The method according to claim 3, wherein the crop is a crop to which tolerance to dicamba or a salt thereof is imparted.

6. The method according to claim 2, wherein the habitat of the dicamba-resistant weed is a cultivation area of a crop.
